(19) United States
(12) Patent Application Publication
(10) Pub. No.: US 2021/0241538 A1
(43) Pub. Date: Aug. 5, 2021

(54) SUPPORT IMAGE DISPLAY APPARATUS, SUPPORT IMAGE DISPLAY METHOD, AND COMPUTER READABLE MEDIUM

(71) Applicant: MITSUBISHI ELECTRIC CORPORATION, Tokyo (JP)

(72) Inventor: Naoyuki TSUSHIMA, Tokyo (JP)

(73) Assignee: MITSUBISHI ELECTRIC CORPORATION, Tokyo (JP)

(21) Appl. No.: 16/098,719

(22) PCT Filed: Jun. 20, 2016
(86) PCT No.: PCT/JP2016/068246

§ 371 Date: Nov. 2, 2018

(51) Int. Cl. G06T 19/20; G06T 19/00

(52) U.S. Cl. CPC G06T 19/20; G06T 2219/2004; G06T 19/006

(57) ABSTRACT

A support image display apparatus displays a support image that points out an object included in a landscape observed from a viewpoint position of a moving body so as to be superimposed on the landscape. An image generation section generates a support image that points out a reference position of the object. A display control section changes, when a complexity of the landscape in a surrounding of the object is high, a display position of the support image generated by the image generation section to a region with a low complexity, and thereafter displays the support image so as to be superimposed on the landscape.

### TECHNICAL FIELD

The present invention relates to a technique for supporting driving, by displaying a support image that points out an object present in front of a vehicle.

### BACKGROUND ART

A driver drives while grasping various information presented by a driving support apparatus such as a navigation apparatus.

Examples of the driving support apparatus include an apparatus, such as a head-up display, that displays a support image indicating a name of the building and the like by being superimposed on the front landscape, on a windshield. Moreover, examples of the driving support apparatus include an apparatus that displays a front landscape photographed by a camera on a displaying section such as a LCD (Liquid crystal display), and displays a support image by being superimposed on the landscape.

When a landscape serving as a background of a support image is complex, a driver becomes difficult to visually recognize the support image displayed by being superimposed on the landscape, so that the driver may not be aware of the support image and may erroneously recognize information on the support image in some cases.

Patent Literature 1 describes controlling the display luminance of a display image on the basis of the spatial frequency of the luminance of a landscape. This improves the visibility of the display image in Patent Literature 1.

### CITATION LIST

### Patent Literature

Patent Literature 1: JP-A-2013-174667

### SUMMARY OF INVENTION

### Technical Problem

In the technique described in Patent Literature 1, even when the luminance of the landscape is high, the luminance of the display image needs to exceed the luminance of the landscape. This results in the reduction of the visibility when the luminance that can be displayed is limited.

An object of the present invention is to display a support image in a state where a driver is easy to visually recognize the support image.

### Solution to Problem

A support image display apparatus according to the present invention displays a support image to point out an object included in a landscape observed from a viewpoint position of a moving body so as to be superimposed on the landscape, and the support image display apparatus includes:

an image generation section to generate the support image that points out a reference position of the object; and

a display control section to change a position of the support image generated by the image generation section in accordance with a complexity of the landscape in a surrounding of the object, and thereafter display the support image.

### Advantageous Effects of Invention

With the present invention, it is possible to display a support image in a state where a driver is easy to visually recognize the support image by changing a position of the support image in accordance with the complexity.

### BRIEF DESCRIPTION OF DRAWINGS

FIG. 1 is a structural diagram of a support image display apparatus 10 according to an embodiment 1.

FIG. 2 is a flowchart of overall processing of the support image display apparatus 10 according to the embodiment 1.

FIG. 3 is an explanation view of a support image 41 according to the embodiment 1, and is a view of the support image 41 seen from the above.

FIG. 4 is an explanation view of the support image 41 according to the embodiment 1, and is a view of the support image 41 seen from a viewpoint position.

FIG. 5 is a view illustrating a state where the support image 41 according to the embodiment 1 is moved.

FIG. 6 is a flowchart of an image generation process in step S1 according to the embodiment 1.

FIG. 7 is a flowchart of a complexity determination process in step S2 according to the embodiment 1.

FIG. 8 is an explanation view of a display object area 71 according to the embodiment 1.

FIG. 9 is an explanation view of rectangular regions into which the display object area 71 according to the embodiment 1 is divided.

FIG. 10 is a view representing two-dimensional spatial frequencies of the respective rectangular regions according to the embodiment 1.

FIG. 11 is a flowchart of a display control process in step S3 according to the embodiment 1.

FIG. 12 is a structural diagram of the support image display apparatus 10 according to a first modification example.

FIG. 13 is a flowchart of a complexity determination process in step S2 according to an embodiment 2.

FIG. 14 is an explanation view of an invisible area 55 according to the embodiment 2.

FIG. 15 is an explanation view of the invisible area 55 according to the embodiment 2.

FIG. 16 is a view illustrating a state where the support image 41 according to the embodiment 2 is moved.

### DESCRIPTION OF EMBODIMENTS

### Embodiment 1

***Description of Configuration***

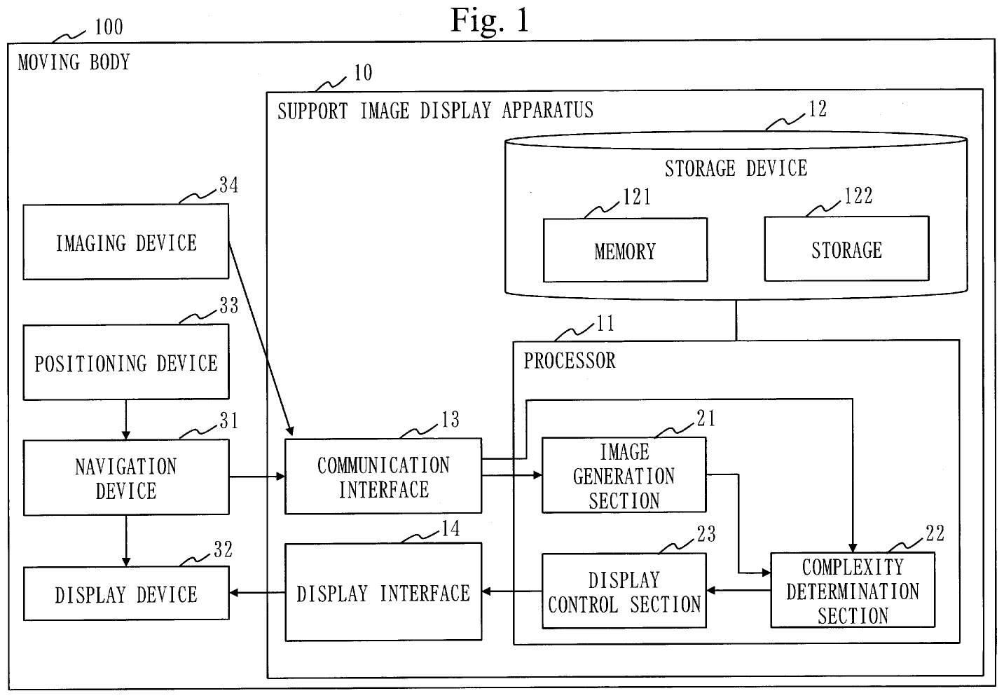

A configuration of a support image display apparatus 10 according to an embodiment 1 will be described with reference to FIG. 1.

The support image display apparatus 10 is mounted on a moving body 100, and is a computer for performing display control of POI (point of interest) information that a navigation device 31 intends to cause a display device 32 to display. The moving body 100 is a vehicle in the embodiment 1. The moving body 100 is not limited to a vehicle, but may be of other types, such as a ship and a pedestrian.

It should be noted that the support image display apparatus 10 may be mounted on the moving body 100 or other illustrated components in an integral form or a non-detachable form, or may be mounted in a removable form or a detachable form.

The support image display apparatus 10 is provided with a processor 11, a storage device 12, a communication interface 13, and a display interface 14. The processor 11 is connected to other hardware via signal lines, and controls the other hardware.

The processor 11 is an IC (Integrated Circuit) for processing. As a specific example, the processor 11 is a CPU (Central Processing Unit), a DSP (Digital Signal Processor), or a GPU (Graphics Processing Unit).

The storage device 12 is provided with a memory 121 and a storage 122. As a specific example, the memory 121 is a RAM (Random Access Memory). As a specific example, the storage 122 is an HDD (Hard Disk Drive). Moreover, the storage 122 may be a portable storage medium such as an SD (Secure Digital) memory card, a CF (Compact Flash), an NAND flash, a flexible disk, an optical disk, a compact disk, a Blu-ray (registered trademark) disk, or a DVD (Digital Versatile Disk).

The communication interface 13 is a device for connecting thereto devices such as the navigation device 31 and an imaging device 34 that are mounted on the moving body 100. As a specific example, the communication interface 13 is a connection terminal of a USB (Universal Serial Bus) or an IEEE1394.

The navigation device 31 is a computer for specifying a position of the moving body 100 using a positioning device 33, and causing the display device 32 to display thereon a route to a destination or a waypoint on the basis of the specified position, thereby performing a route guidance to the destination or the waypoint. Moreover, the navigation device 31 includes map information, and is a computer for causing the display device 32 to display thereon POI information designated by a driver or automatically extracted, thereby presenting the POI information to the driver.

The POI information is information on an object that the driver is assumed to be interested in, and is information indicating a position, a shape, and the like of the object. As a specific example, when the driver designates a classification, such as a pharmacy or a restaurant, the POI information is information on an object that corresponds to the designated classification.

The positioning device 33 is a device for receiving a positioning signal transmitted on carrier waves from a positioning satellite such as a GPS (Global Positioning System) satellite.

The imaging device 34 is attached so as to be capable of photographing the surrounding of the moving body 100, such as the front of the moving body 100, and a device for outputting a photographed video. In the embodiment 1, the imaging device 34 photographs the front of the moving body 100.

The display interface 14 is a device for connecting thereto the display device 32 that is mounted on the moving body 100. As a specific example, the display interface 14 is a connection terminal of a USB or an HDMI (registered trademark, High-Definition Multimedia Interface).

The display device 32 is a device for displaying information by being superimposed on a landscape of the surrounding of the moving body 100, such as the front of the moving body 100, that is observed from a viewpoint position of the moving body 100. In the embodiment 1, the display device 32 displays information by being superimposed on the front landscape of the moving body 100. The landscape referred herein is any one of a real object that can be seen via a head-up display or the like, a video that is acquired by a camera, and a three-dimensional map that is created using computer graphics. The viewpoint position is a position of the viewpoint of a driver of the moving body 100 in the embodiment 1. It should be noted that the viewpoint position may be a viewpoint position of a passenger other than the driver, or may be a viewpoint position of a camera when the landscape is displayed as a video that is acquired by the camera.

The support image display apparatus 10 is provided with, as a functional configuration, an image generation section 21, a complexity determination section 22, and a display control section 23. The functions of the respective sections of the image generation section 21, the complexity determination section 22, and the display control section 23 are implemented by software.

A program that implements the function of each of the sections of the support image display apparatus 10 is stored in the storage 122 of the storage device 12. This program is read by the processor 11 into the memory 121, and executed by the processor 11. Accordingly, the functions of the respective sections of the support image display apparatus 10 are implemented.

Information indicating the result of a process of the function of each section that is implemented by the processor 11, data, a signal value, and a variable value are stored in the memory 121, or a register or a cache memory in the processor 11. In the following description, description will be made by assuming that information indicating the result of a process of the function of each section that is implemented by the processor 11, data, a signal value, and a variable value are assumed to be stored in the memory 121.

It has been described that a program that implements each function implemented by the processor 11 is stored in the storage device 12. However, this program may be stored in a portable storage medium such as a magnetic disk, a flexible disk, an optical disk, a compact disk, a Blu-ray (registered trademark) disk, or a DVD.

In FIG. 1, only one processor 11 is illustrated. However, the support image display apparatus 10 may be provided with a plurality of processors as an alternative to the processor 11. The plurality of these processors share the execution of the programs that implement the functions of the respective sections of the support image display apparatus 10. Each of the processors is an IC for processing similar to the processor 11.

***Description of Operation***

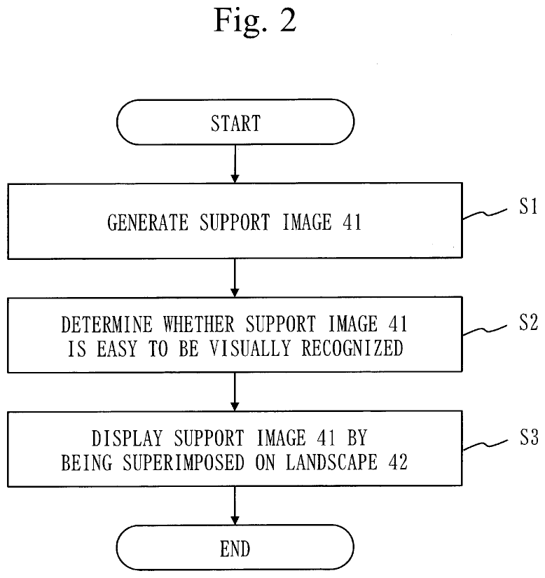

An operation of the support image display apparatus 10 according to the embodiment 1 will be described with reference to FIG. 2 to FIG. 11.

The operation of the support image display apparatus 10 according to the embodiment 1 is equivalent to a support image display method according to the embodiment 1. Moreover, the operation of the support image display apparatus 10 according to the embodiment 1 is equivalent to the process of a support image display program according to the embodiment 1.

Overall processing of the support image display apparatus 10 according to the embodiment 1 will be described with reference to FIG. 2.

The processing illustrated in FIG. 2 is executed when the navigation device 31 causes the display device 32 to display thereon POI information. When POI information is caused to be displayed, the navigation device 31 transmits the POI information to the support image display apparatus 10.

Herein, description will be made by assuming that an object 51 of the POI information is a pharmacy.

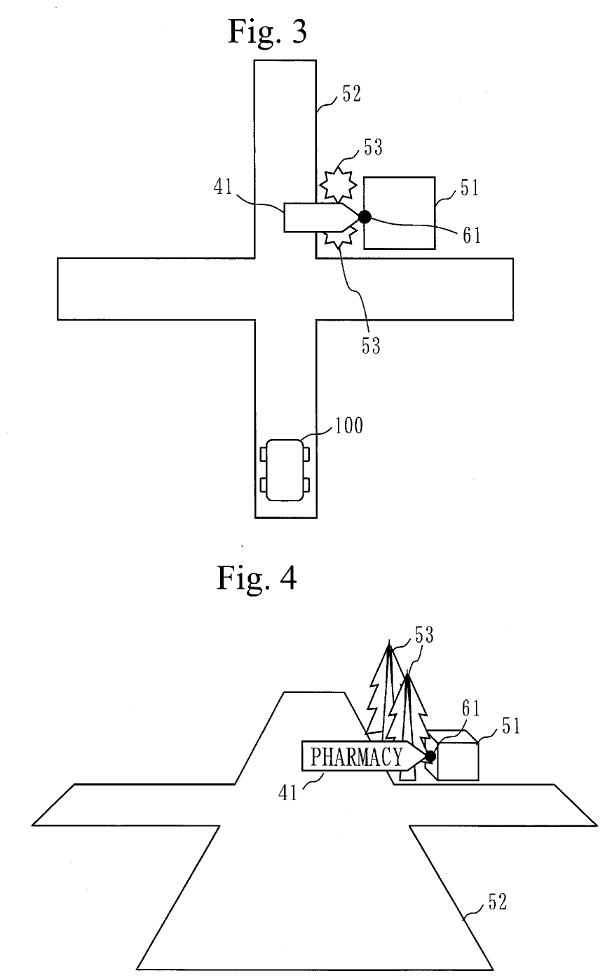

In an image generation process in step S1, as illustrated in FIG. 3 and FIG. 4, the image generation section 21 generates a support image 41 that points out a reference position 61 relative to the object 51 of POI information, and writes the support image 41 into the memory 121.

The reference position 61 is a position serving as a reference when an object is pointed out by the support image. In the embodiment 1, the reference position 61 is a point on the object 51. The reference position 61 may be a point outside the object 51 in the vicinity of the object 51. The support image 41 is an image for pointing out the object 51, and explaining the object, and corresponds to, for example, an image, such as a virtual signboard, that points out the object 51.

In a complexity determination process in step S2, the complexity determination section 22 determines, depending on whether or not the complexity of a region serving as a background of the support image 41 generated in step S21 is higher than a threshold, whether or not the support image 41 is easy to be visually recognized when the support image 41 is displayed on the display device 32.

In a display control process in step S3, the display control section 23 reads out the support image 41 generated in step S1 from the memory 121. The display control section 23 thereafter causes the display device 32 to display thereon the read-out support image 41 by being superimposed on a landscape 42.

At this time, if it is determined in step S2 that the complexity is not higher than the threshold, in other words, that the support image 41 is easy to be visually recognized, the display control section 23 causes the display device 32 to display thereon the read-out support image 41 without any change by being superimposed on the landscape 42. In other words, if the complexity of the landscape 42 of the region serving as the background of the support image 41, is not higher than the threshold, the display control section 23 causes the display device 32 to display thereon the read-out support image 41 without any change by being superimposed on the landscape 42.

On the other hand, if it is determined in step S2 that the complexity is higher than the threshold, in other words, the support image 41 is difficult to be visually recognized, the display control section 23 changes a position of the read-out support image 41, and thereafter causes the display device 32 to display thereon the read-out support image 41 by being superimposed on the landscape 42 in the surrounding of the moving body 100. In other words, if the complexity of the landscape 42 of the region serving as the background of the support image 41, is higher than the threshold, the display control section 23 changes the position of the read-out support image 41, and thereafter causes the display device 32 to display thereon the read-out support image 41 by being superimposed on the landscape 42.

It should be noted that the display control section 23 may further change a display mode of the read-out support image 41, and then causes the read-out support image 41 to be displayed.

In other words, when standing trees 53 are present in the region serving as the background of the support image 41 as illustrated in FIG. 3, the display control section 23 causes the display device 32 to display thereon the read-out support image 41 without any change by being superimposed on the landscape 42 to result in the overlapping of the support image 41 and the standing trees 53 as illustrated in FIG. 4. As a result, the support image 41 is difficult to be visually recognized.

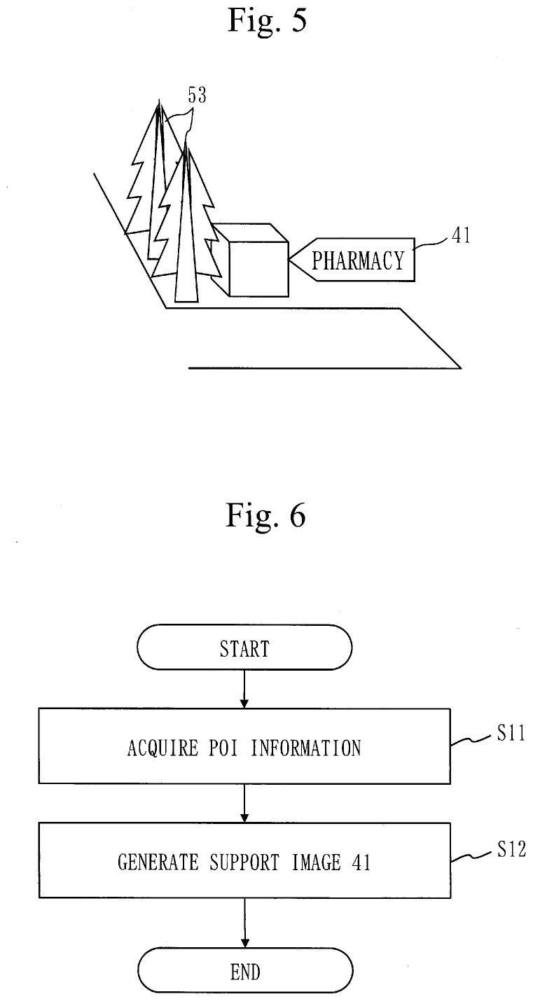

Therefore, the display control section 23 shifts the position at which the support image 41 points out to the right side of the object 51 as illustrated in FIG. 5, and thereafter causes the display device 32 to display thereon the support image 41. Accordingly, the landscape of the region serving as the background of the support image 41 is not complex, so that the support image 41 is easy to be visually recognized.

The image generation process in step S1 according to the embodiment 1 will be described with reference to FIG. 6.

In step S11, the image generation section 21 acquires POI information transmitted from the navigation device 31 via the communication interface 13. The image generation section 21 writes the acquired POI information into the memory 121.

The POI information is information indicating a position and a shape of the object 51. In the embodiment 1, it is assumed that information indicating the shape of the object 51 indicates a planar shape when the object 51 is seen from the sky, and the planar shape of the object 51 is a rectangle. Further, the POI information is information indicating the latitude and the longitude at the four points of upper-left, upper-right, lower-left, and lower-right when the object 51 is seen from the sky. Herein, because the object 51 is a pharmacy, the POI information is information indicating the latitude and the longitude at the four points about the pharmacy present in the surrounding of the moving body 100.

In step S12, the image generation section 21 generates the support image 41 that points out the object 51 indicated by the POI information acquired in step S11.

Specifically, the image generation section 21 reads out the POI information acquired in step S11, from the memory 121. The image generation section 21 specifies the reference position 61 of the object 51 from the POI information. The image generation section 21 thereafter generates the support image 41 that points out the specified reference position 61 of the object 51, and extends in a reference direction. In the embodiment 1, the reference direction is a direction in which a road 52 on which the moving body 100 travels is present relative to the reference position 61. The image generation section 21 writes the calculated reference position 61 and the generated support image 41 into the memory 121.

As a specific example of a method of specifying the reference position 61, the image generation section 21 specifies, from the latitude and the longitude at the four points indicated by the POI information, a point among the four points that is the closest to the road 52 of the object 51. When there are two points that are the closest to the road 52, the image generation section 21 selects either one. The image generation section 21 calculates a position that is shifted by a constant distance from the specified point toward a point positioned at a diagonal of the object 51. The image generation section 21 calculates a position in which the calculated position is shifted by a reference height in the height direction, in other words, a position that is shifted from the surface of the earth in the vertical direction, and sets the calculated position as the reference position 61.

In FIG. 3 and FIG. 4, the support image 41 is an image having an arrow shape. Further, the support image 41 is an image that includes a tip of the arrow the position of which is overlapped with the reference position 61, and extends toward the road 52. Moreover, the support image 41 is an image in which the name, the type, or the like of the object 51 is illustrated. The support image 41 is not limited to the arrow shape, but may be other shapes, such as a balloon.

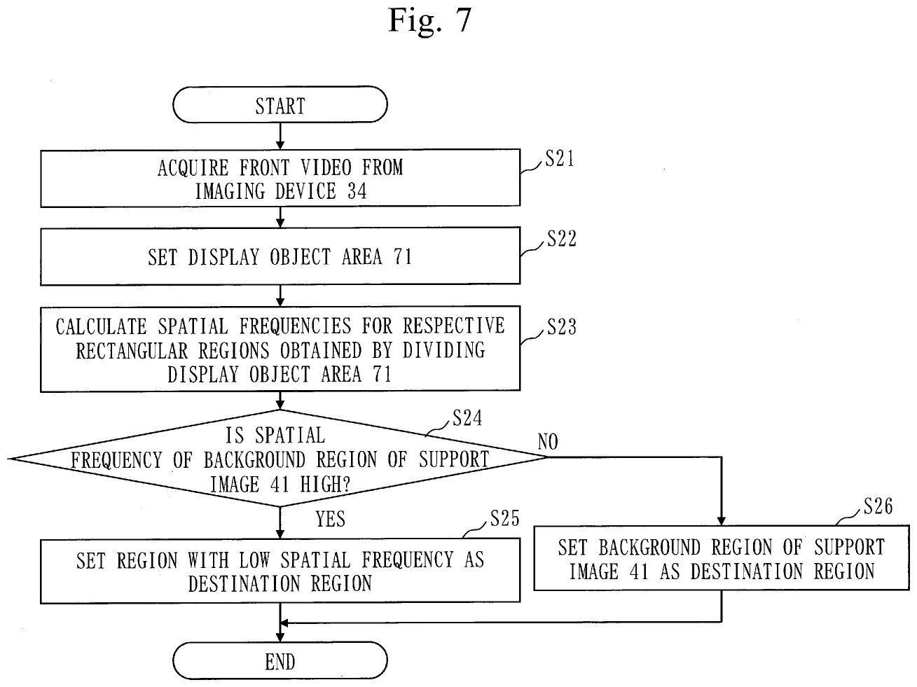

The complexity determination process in step S2 according to the embodiment 1 will be described with reference to FIG. 7.

In step S21, the complexity determination section 22 acquires a video of the front of the moving body 100 photographed by the imaging device 34, via the communication interface 13. The complexity determination section 22 writes the acquired video into the memory 121.

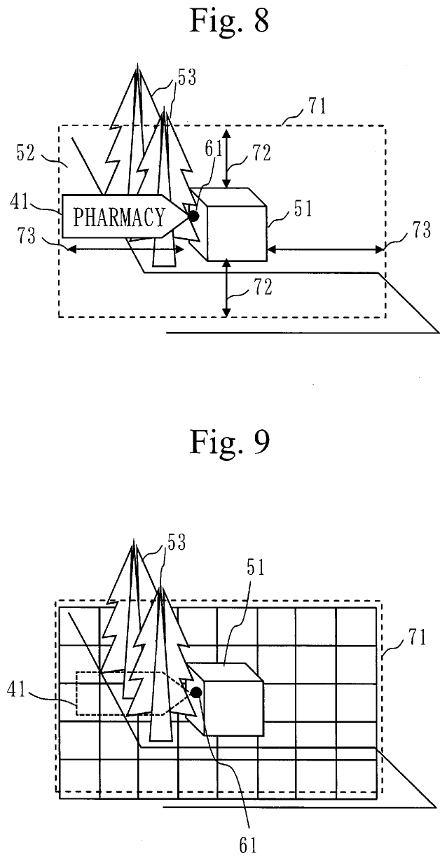

In step S22, the complexity determination section 22 sets a display object area 71 in the surrounding of the object 51 to a front video, as illustrated in FIG. 8. The display object area 71 represents an area in which the support image 41 can be disposed.

Specifically, the complexity determination section 22 sets a quadrangular region that is apart by a height distance 72 in the height direction and is apart by a horizontal distance 73 in the horizontal direction, from an outer circumference of the object 51, as the display object area 71. The height distance 72 and the horizontal distance 73 are decided in advance.

In step S23, the complexity determination section 22 divides the display object area 71 into a plurality of rectangular regions, as illustrated in FIG. 9. The respective rectangular regions have the same size, that is the size decided in advance. Further, the complexity determination section 22 calculates a two-dimensional spatial frequency for an image of each rectangular region. The calculation of the two-dimensional spatial frequency is implemented using the existing method, such as a DCT (Discrete Cosine Transform).

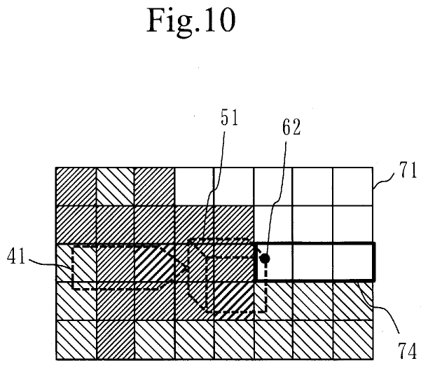

FIG. 10 illustrates the level difference of the two-dimensional spatial frequencies of the respective rectangular regions when being expressed using the hatching density. FIG. 10 indicates that as the hatching density is higher, the two-dimensional spatial frequency is higher. The two-dimensional spatial frequency becomes higher, as the image of the rectangular region is more complex. For example, the two-dimensional spatial frequency becomes high in a case of an image with fine tiled patterns, whereas the two-dimensional spatial frequency becomes low in a case of an image with no pattern.

In step S24, the complexity determination section 22 determines, by setting the spatial frequency for the region serving as the background of the support image 41 as a complexity, whether the complexity is higher than a threshold.

Specifically, the complexity determination section 22 calculates a mean value of the spatial frequencies for all the rectangular regions that are included in a region where the support image 41 generated in step S1 is displayed. The complexity determination section 22 thereafter determines, by setting the calculated mean value as a complexity for the region serving as the background of the support image 41, whether the complexity is higher than a threshold decided in advance.

The complexity determination section 22 proceeds the processing to step S25 if the complexity is higher than the threshold, whereas proceeds the processing to step S26 if the complexity is not higher than the threshold.

In step S25, the complexity determination section 22 sets a combination of rectangular regions having a size necessary for displaying the support image 41 inside the display object area 71 as a target region. The complexity determination section 22 thereafter calculates a mean value of two-dimensional spatial frequencies for the respective target regions. In FIG. 10, three rectangular regions continuous in the transverse direction are necessary for displaying the support image 41. Therefore, the complexity determination section 22 calculates, by setting a combination of the three rectangular regions continuous in the transverse direction as a target region, a mean value of two-dimensional spatial frequencies for each target region.

The complexity determination section 22 specifies, by setting the calculated mean value as a complexity for the target region, a target region with the lowest complexity as a destination region. In FIG. 10, a region 74 is specified as a destination region. The complexity determination section 22 thereafter specifies a point on the object 51 or a point in the vicinity of the object 51 included in the destination region as the new reference position 61. In FIG. 10, a point 62 is specified as the new reference position 61.

In step S26, the complexity determination section 22 specifies the region serving as the background of the support image 41 without any change as a destination region. Moreover, the complexity determination section 22 specifies the reference position 61 calculated in step S12 without any change as the new reference position 61. In other words, there is no movement of the support image 41.

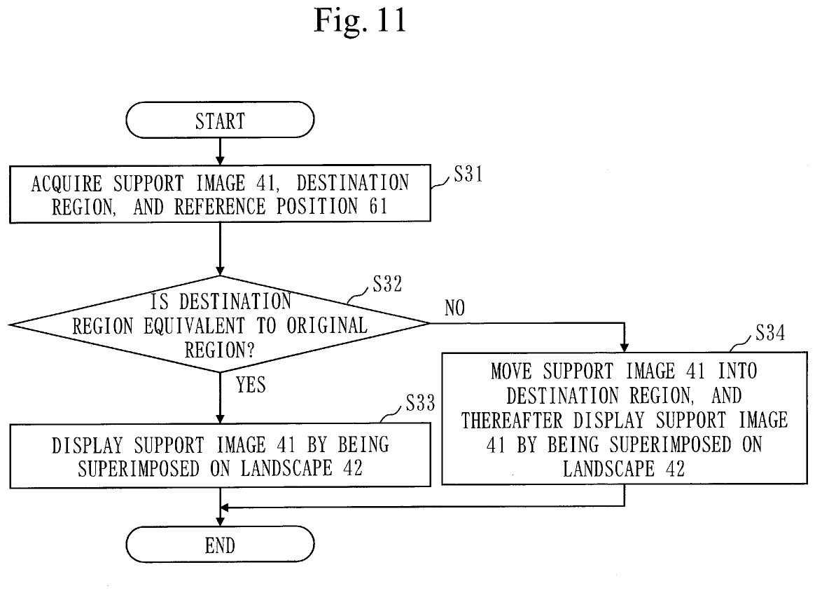

The display control process in step S3 according to the embodiment 1 will be described with reference to FIG. 11.

In step S31, the display control section 23 reads out and acquires the support image 41 generated in step S12, and the destination region and the new reference position 61 specified in step S25 or in step S26, from the memory 121.

In step S32, the display control section 23 determines whether the destination region acquired in step S31 is equivalent to the region serving as the background of the support image 41. In other words, the display control section 23 determines the presence/absence of movement of the support image 41.

The display control section 23 proceeds the processing to step S33 if the destination region is equivalent to the region serving as the background of the support image 41, whereas proceeds the processing to step S34 if different.

In step S33, as illustrated in FIG. 4, the display control section 23 causes the display device 32 to display thereon the support image 41 acquired in step S31 without any change by being superimposed on the landscape.

In step S34, the display control section 23 moves the support image 41 acquired in step S31 so as to point out the reference position 61 acquired in step S31, and make the destination region serve as the background, and thereafter causes the display device 32 to display thereon the support image 41 by being superimposed on the landscape. In other words, as illustrated in FIG. 5, the display control section 23 moves the support image 41 into the destination region, and thereafter causes the display device 32 to display thereon the support image 41 by being superimposed on the landscape.

### Effects of the Embodiment 1

As in the foregoing, when the complexity of the landscape of the region serving as the background of the support image 41 is high, and the visibility of the support image 41 is lowered, the support image display apparatus 10 according to the embodiment 1 moves the support image 41 to a region with a low complexity of a landscape, and thereafter causes the support image 41 to be displayed by being superimposed on the landscape. Accordingly, it is possible to display the support image in a state where the driver is easy to visually recognize the support image.

***Other Configurations***

### First Modification Example

The functions of the respective sections of the support image display apparatus 10 are implemented by software in the embodiment 1. Meanwhile, as a first modification example, the functions of the respective sections of the support image display apparatus 10 may be implemented by hardware. As for the first modification example, points different from those in the embodiment 1 will be described.

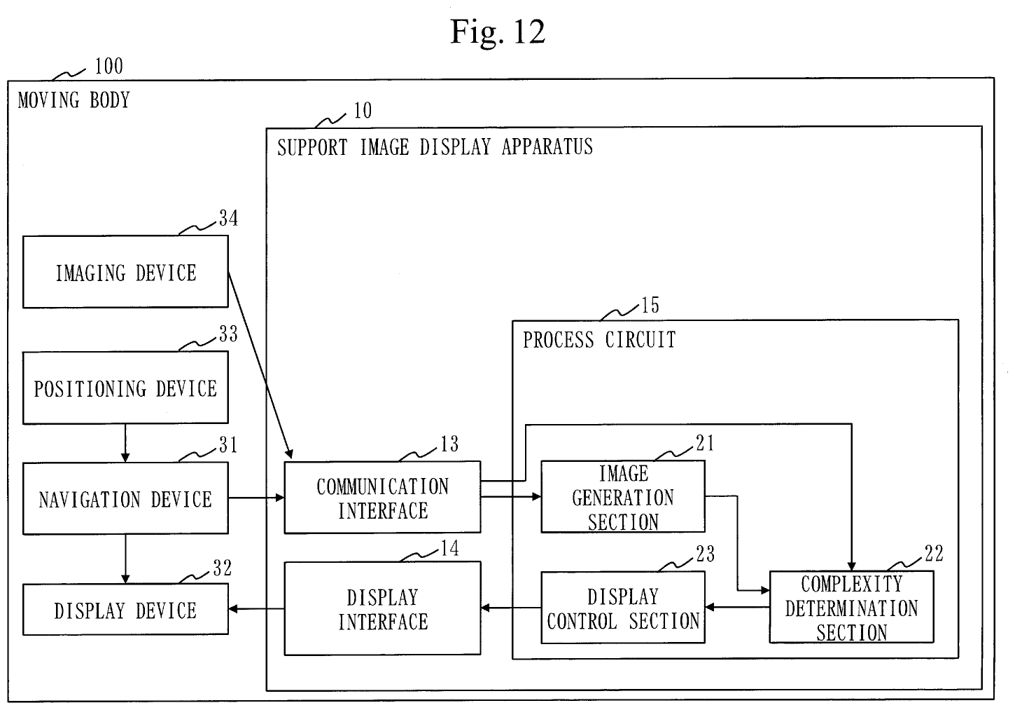

The configuration of the support image display apparatus 10 according to the first modification example will be described with reference to FIG. 12.

When the functions of the respective sections are implemented by hardware, the support image display apparatus 10 is provided with a process circuit 15, instead of the processor 11 and the storage device 12. The process circuit 15 is a dedicated electronic circuit that implements the functions of the respective sections of the support image display apparatus 10 and the function of the storage device 12.

The process circuit 15 is assumed to be a single circuit, a composite circuit, a programmed processor, a parallel-programmed processor, a logic IC, a GA (Gate Array), an ASIC (Application Specific Integrated Circuit), or an FPGA (Field-Programmable Gate Array).

The functions of the respective sections may be implemented by the single process circuit 15, or the functions of the respective sections may be implemented by being distributed to a plurality of the process circuits 15.

### Second Modification Example

As a second modification example, a part of the functions may be implemented by hardware, and the other functions may be implemented by software. In other words, out of the respective sections of the support image display apparatus 10, a part of the functions may be implemented by hardware, and the other functions may be implemented by software.

The processor 11, the storage device 12, and the process circuit 15 are collectively referred to as “processing circuitry”. In other words, the functions of the respective sections are implemented by the processing circuitry.

### Embodiment 2

An embodiment 2 is different from the embodiment 1 in that when a structural object 54 is present between the moving body 100 and the object 51, the support image 41 is moved so as to point out a position that can be visually recognized from a viewpoint position. In the embodiment 2, this different point will be described.

***Description of Operation***

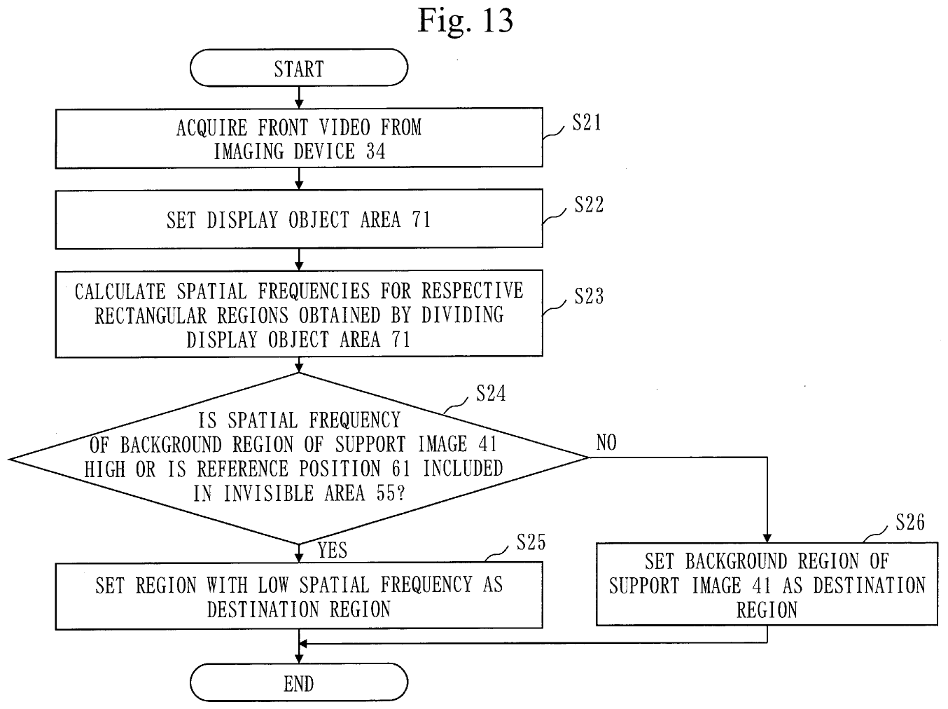

An operation of the support image display apparatus 10 according to the embodiment 2 will be described with reference to FIG. 13 to FIG. 16.

The operation of the support image display apparatus 10 according to the embodiment 2 is equivalent to a support image display method according to the embodiment 2. Moreover, the operation of the support image display apparatus 10 according to the embodiment 2 is equivalent to the process of a support image display program according to the embodiment 2.

The complexity determination process in step S2 according to the embodiment 2 will be described with reference to FIG. 13.

The processes from step S21 to step S23 and the process in step S26 are the same as those in the embodiment 1.

In step S24, similar to the embodiment 1, the complexity determination section 22 determines, by setting the spatial frequency for the region serving as the background of the support image 41 as a complexity, whether the complexity is higher than a threshold.

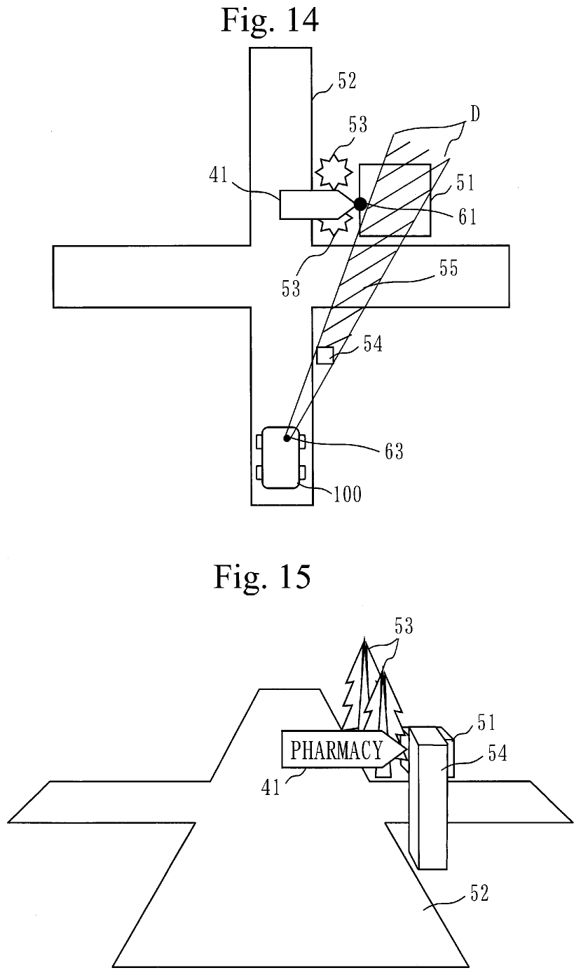

Moreover, as illustrated in FIG. 14 and FIG. 15, the complexity determination section 22 specifies an invisible area 55 that cannot be seen from a viewpoint position 63 due to the structural object 54 that is present between the viewpoint position 63 and the object 51.

Specifically, as illustrated in FIG. 14, the complexity determination section 22 calculates two straight lines D that each pass through the viewpoint position 63 and either end tip of the structural object 54. Herein, it is assumed that the shape of the structural object 54 is a rectangle similar to that of the object 51, and the latitude and the longitude at the four points of upper-left, upper-right, lower-left, and lower-right when the structural object 54 is seen from the sky are indicated in map information. Accordingly, the complexity determination section 22 can calculate the two straight lines D, by using the right direction relative to the traveling direction of the moving body 100 from the viewpoint position 63 as a reference axis, out of straight lines that respectively connect the viewpoint position 63 and the four points of the structural object 54, and calculating a straight line having the minimum angle θ with the reference axis and a straight line having the maximum angle θ with the reference axis. The complexity determination section 22 calculates an area on the back side of the structural object 54 between the two straight lines D2, as the invisible area 55.

The complexity determination section 22 thereafter determines whether the reference position 61 calculated in step S12 is included in the invisible area 55.

In at least either one of a case where the complexity is higher than the threshold and a case where the reference position 61 calculated in step S12 is included in the invisible area 55, the complexity determination section 22 proceeds the processing to step S25. In a case other than these cases, the complexity determination section 22 proceeds the processing to step S26.

In step S25, the complexity determination section 22 sets, out of combinations of the rectangular regions having a size necessary for displaying the support image 41 inside the display object area 71, a combination of the rectangular regions including an area not included in the invisible area 55 and being on the object 51, as a target region. The complexity determination section 22 thereafter calculates, similar to the embodiment 1, a mean value of two-dimensional spatial frequencies for the respective target regions, and specifies, by setting the calculated mean value as a complexity for the target region, a target region with the lowest complexity as a destination region. Moreover, the complexity determination section 22 specifies a point on the object 51 or a point in the vicinity of the object 51 in a range not included in the invisible area 55 but included in the destination region, as the new reference position 61.

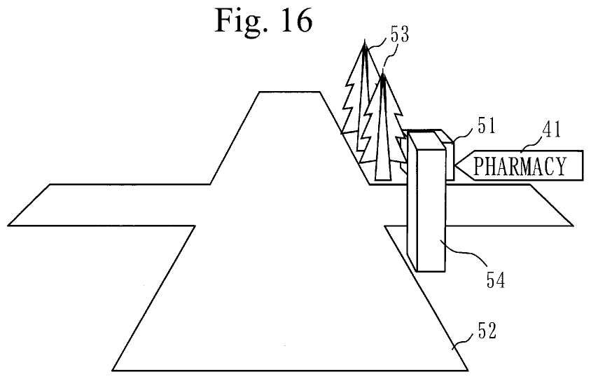

As a result, in step S34, as illustrated in FIG. 16, the display control section 23 moves the support image 41 into the destination region with the low complexity of the landscape and not being shielded by the structural object 54, and thereafter causes the display device 32 to display thereon the support image 41 by being superimposed on the landscape.

### Effects of the Embodiment 2

As in the foregoing, the support image display apparatus 10 according to the embodiment 2 moves the support image 41 to the region with the low complexity of the landscape and not being shielded by the structural object 54, and thereafter causes the support image 41 to be displayed by being superimposed on the landscape. Accordingly, it is possible to display the support image 41 also with respect to the object 51 that a driver cannot see a part thereof due to the structural object 54, in a state where the driver is easy to understand.

### REFERENCE SIGNS LIST

10: support image display apparatus, 11: processor, 12: storage device, 121: memory, 122: storage, 13: communication interface, 14: display interface, 15: process circuit, 21: image generation section, 22: complexity determination section, 23: display control section, 31: navigation device, 32: display device, 33: positioning device, 34: imaging device, 41: support image, 51: object, 52: road, 53: standing tree, 54: structural object, 55: invisible area, 61: reference position, 62: point, 63: viewpoint position, 71: display object area, 72: height distance, 73: horizontal distance, 74: region, 100: moving body.

1-7. (canceled)

8. A support image display apparatus that displays a support image to point out an object included in a landscape observed from a viewpoint position of a moving body so as to be superimposed on the landscape, the support image display apparatus comprising:
processing circuitry to:
generate the support image that points out a reference position of the object;
determine whether a complexity of a landscape of a region serving as a background of the generated support image is higher than a threshold; and
when the complexity of the landscape of the region serving as the background is determined to be higher than the threshold, change a position of the generated support image such that a position pointed out by the support image becomes a position that can be visually recognized by the moving body and the position is in a region with a low complexity, out of regions in a surrounding of the reference position, and thereafter display the support image.

9. The support image display apparatus according to claim 8, wherein the processing circuitry calculates a two-dimensional spatial frequency of the landscape of the region serving as the background to specify the complexity.

10. The support image display apparatus according to claim 9, wherein the processing circuitry calculates a two-dimensional spatial frequency for each of a plurality of regions obtained by dividing the surrounding of the reference position, and specifies the complexity for each of the regions, and
when the complexity of the region serving as the background is higher than the threshold, changes the position of the support image to the region with the low complexity, and thereafter displays the support image.

11. A support image display method that displays a support image to point out an object included in a landscape observed from a viewpoint position of a moving body so as to be superimposed on the landscape, the support image display method comprising:
generating the support image that points out a reference position of the object;
determining whether a complexity of a landscape of a region serving as a background of the support image is higher than a threshold; and
when the complexity of the landscape of the region serving as the background is higher than the threshold, changing a position of the support image such that a position pointed out by the support image becomes a position that can be visually recognized by the moving body and the position is in a region with a low complexity, out of regions in a surrounding of the reference position, and thereafter displaying the support image.

12. A non-transitory computer readable medium storing a support image display program that displays a support image to point out an object included in a landscape observed from a viewpoint position of a moving body so as to be superimposed on the landscape, the support image display program causing a computer to execute:
an image generation process to generate the support image that points out a reference position of the object;
a complexity determination process to determine whether a complexity of a landscape of a region serving as a background of the support image generated by the image generation process is higher than a threshold; and
a display control process to, when the complexity of the landscape of the region serving as the background is determined to be higher than the threshold by the complexity determination process, change a position of the support image generated by the image generation process such that a position pointed out by the support image becomes a position that can be visually recognized by the moving body and the position is in a region with a low complexity, out of regions in a surrounding of the reference position, and thereafter display the support image.
